(19) United States
(12) Patent Application Publication
(10) Pub. No.: US 2017/0108128 A1
(43) Pub. Date: Apr. 20, 2017

(54) Universal Quarter Turn Ball Valve Assembly

(71) Applicant: Scott T. Conway, Sylvania, OH (US)

(72) Inventor: Scott T. Conway, Sylvania, OH (US)

(21) Appl. No.: 15/295,322

(22) Filed: Oct. 17, 2016

Related U.S. Application Data
(60) Provisional application No. 62/242,339, filed on Oct. 16, 2015.

(51) Int. Cl. F16K 11/087; F16K 37/00; F16K 35/06; F16K 31/60

(52) U.S. Cl. CPC F16K 11/0876; F16K 31/602; F16K 37/0008; F16K 35/06

(57) ABSTRACT

A quarter turn ball valve assembly comprises a valve housing having cylindrical collar, a fluid inlet in said housing, and a fluid outlet in said housing. A ball having an internal passageway is supported for rotation in a collar in the housing and rotation of a valve stem supported in the housing causes rotation of the ball. A free end of the valve stem is within a collar and does not extend beyond the collar. The collar has cut-outs defining tabs. A handle engages the valve stem and wings on the handle restrict engagement between the handle and the valve stem to specific relative angular orientations therebetween, to prevent the handle from being secured to the valve stem in the wrong angular relationship.

### BACKGROUND OF THE INVENTION

1. Field of the Invention

This invention is a universal quarter turn ball valve assembly readily useable in multiple applications and can be operated by all manners of knobs, handles, keys, levers, and the like.

2. Description of the Prior Art

In the course of a patent search directed to the present invention, the following US patents were noted:
U.S. Pat. Nos. 8,944,404; 8,490,947; 8,282,073; 7,306,010; 7,296,589; 7,124,999; 7,080,821; 6,640,390; 6,575,429; 6,382,590; 5,785,074; 5,152,503; 5,090,447; 4,846,221; D297,355; 4,725,042; 4,667,926; 4,416,305; 4,218,042; 4,103,865; 4,081,172; 4,051,866; 3,827,671; 3,475,006; 3,380,472; 3,168,280; 3,038,695; 2,994,341; and 2,642,257.

Fluid valves for controlling the flow of gas to, for example, gas fireplaces, are known. A gas valve key engages flats on the top of a valve stem to open and close the valve. The top of the valve stem extends above an externally threaded neck portion of the valve housing. A tamper proof assembly is achieved when an internally threaded gas fireplace valve cover or escutcheon is screwed onto the neck portion of the valve housing to keep little hands from accessing the exposed top of the valve stem and opening the valve. In a known quarter turn ball valve used for this application, a radially extending pin supported in the valve stem has ends that extend into slots cut-out in the neck portion of the valve body, and rotation of the valve stem is limited to a quarter turn by coaction between the pin and the ends of the slots. An example of this type of prior art valve is shown in FIG. 1. It clearly shows that the top of the valve stem which has the flats extends above the externally threaded neck portion of the valve housing.

U.S. Pat. No. 8,944,404 discloses an in line ball valve with a knob that engages one end of a valve stem while the other end of the valve stem engages a ball so that rotation of the knob causes rotation of the ball. Rotation of the knob and the valve stem is limited to ninety degrees by cooperation between two fins 32 and 33 provided on the top of the valve housing and two circular segments 37 and 38 defined in the knob.

The gas valve key described above will not properly actuate the valve described in the aforementioned patent and the knob described in the patent will not properly actuate the prior art valve shown in FIG. 1.

U.S. Pat. No. 5,152,503 discloses a dual inlet/dual outlet quarter turn ball valve actuated by a gas valve key. The knob described in U.S. Pat. No. 8,944,404 will not operate the prior art valve shown in U.S. Pat. No. 5,152,503.

### SUMMARY OF THE INVENTION

The invention is a quarter turn valve assembly that is universal in the sense that it can be operated/actuated by several different types of handles, knobs, levers, and keys. The valve assembly has at least one inlet and at least one outlet and a quarter turn ball valve mechanism to control the flow of fluid therethrough.

### BRIEF DESCRIPTION OF THE DRAWING FIGURES

FIG. 1 is a perspective view of a prior art valve assembly.

FIG. 2 is a perspective view of a valve assembly according to one embodiment of the invention with the valve closed.

FIG. 2a is a perspective view of a valve assembly according to one embodiment of the invention with the valve open.

FIG. 3 is a perspective view of the valve assembly shown in FIG. 2 with a handle or knob seated on the valve stem.

FIG. 4 is a perspective view of the valve assembly shown in FIG. 2 with an internally threaded gas fireplace valve cover mounted on a portion of the valve housing that surrounds the valve stem.

FIG. 5 is a perspective view of the valve assembly shown in FIG. 2 with a loose valve stem key engaging the top of the valve stem.

FIG. 6 is an exploded perspective view of the valve assembly shown in FIG. 2 with an adapter and a lever operable to engage the top of the valve stem.

FIG. 7 is a lower perspective view of a handle of the type shown in FIG. 3.

FIG. 8 is a side view of the valve assembly shown in FIG. 2

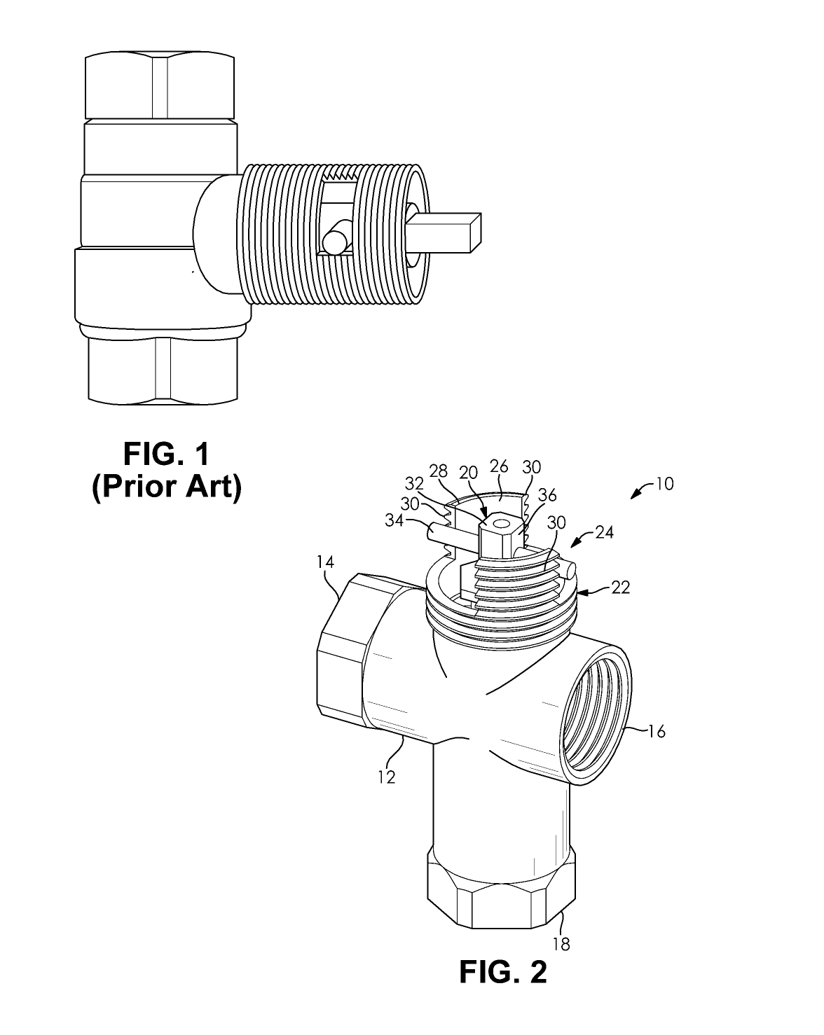

### DETAILED DESCRIPTION OF EMBODIMENTS OF THE INVENTION

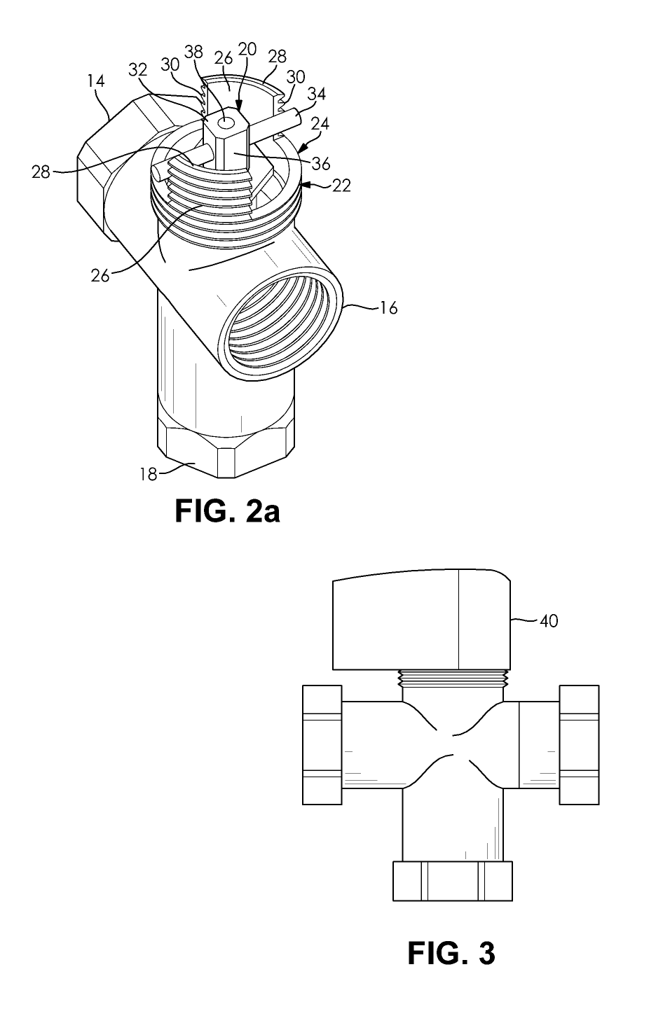

A valve assembly indicated generally at 10 in FIG. 2 comprises a housing 12 having a first port 14, a second port 16, and a third port 18. An internal ball (not shown) is supported for rotation inside of the housing 12. The ball is coupled to the first end (not shown) of a valve stem 20 so that rotation of the stem 20 causes rotation of the ball. Internal passageways are provided in the ball, such as ball passageways 72 shown and described in my U.S. Pat. No. 7,975,720, the entire disclosure of which is explicitly incorporated herein by reference. In a first rotational position of the ball, the ports 14, 16, and 18 are not in communication with each other. In a second rotational position of the ball, ninety degrees offset from the first position, all of the ports are in communication with each other. Thus, any one of the ports 14, 16, and 18 can be an inlet while the other two ports are outlets. Typically, one of the ports that is not an inlet is capped so that there is, in effect, a single outlet. In any case, it is to be understood, and this is very important, that the present invention is applicable to any quarter turn ball valve having at least one inlet port and at least one outlet port.

The valve housing 12 includes an externally threaded collar 22. Portions of the collar 22 are cut-out, as indicated at 24, leaving outwardly extending tabs 26 having free ends 28. Each tab 26 has two sides 30. At least one of the sides 30 of each tab constitutes a stop surface. The collar 22 surrounds a portion of the valve stem 20. A second, free end 32 of the valve stem 20 is between the tabs 26, and the free end 32 of the valve stem 20 does not extend beyond the free ends 28 of the tabs 26.

A pin 34 extends laterally through the valve stem 20. When the ball is in the first, closed, rotational position, the valve stem 20 is in a first rotational position as shown in FIG. 2. When the ball is in the second, open, rotational position, the valve stem 20 is in a second rotational position as shown in FIG. 2a. When the valve stem 20 is in the first position, the ends of the pin 34 abut one of the stop surfaces 30 on each of the tabs 26. It is adequate if only one end of the pin 34 abuts one of the stop surfaces 30 on each one of the tabs 26. The pin 34 cooperates with the stop surfaces 30 to limit rotation of the valve stem 20, in this case, to ninety degrees, and the valve stem 20, in turn, causes, and limits, rotation of the ball to ninety degrees. It is preferred that the valve be configured so that it operates conventionally in the sense that the valve stem 20 is rotated in a counter-clockwise direction (looking down on the valve from the top of the valve stem 20) as it moves from the first, closed rotational position (FIG. 2) to the second, open rotational position (FIG. 2a), and vice versa.

The free end 32 of the valve stem has flats 36 to engage, as described below, various handles, knobs, keys and levers. An internally threaded bore 38 extends into the valve stem 20 from the free end 32.

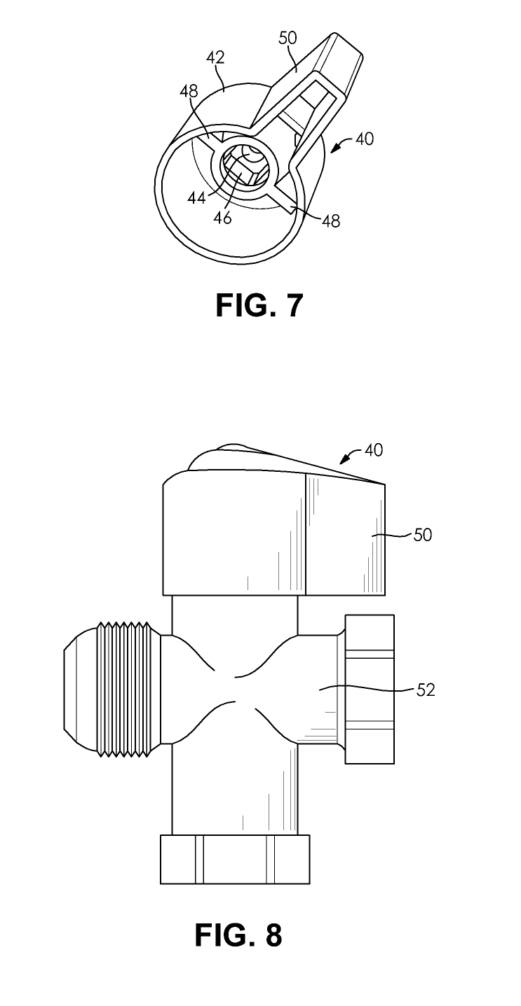

A handle or knob 40 is shown in FIG. 3 attached to the second, free end of the stem 20. The knob 40, shown in more detail in FIG. 7, comprises a side wall 42 which covers most or all of the external threads on the collar 22. A threaded fastener (not shown) extends through an aperture 44 in the handle 40 to engage the internally threaded bore 38 in the second, free end of the valve stem 20 to secure the handle 40 thereto. Internal flats 46 engage the flats 36 on the second end of the valve stem 20 to transmit torque from the handle 40 to the valve stem 20. Stop wings 48 are operable to engage the stops 30 on the tabs 26 when the valve stem 20 is rotated to the first position and also when the valve stem 20 is rotated to the second position so that rotation of the valve stem 20 beyond the first position or the second position is prevented. The knob 40 includes a lever 50 that extends outwardly from the side wall 42.

Convention dictates that, when the lever 50 is aligned with a longitudinally extending portion 52 of the valve housing 12, as shown in FIG. 8, the valve will be open and, further, when the lever 50 is positioned so that it extends laterally relative to the portion 52, the valve will be closed. In the embodiment of the knob 40 shown in FIG. 7, there are four flats 46 which engage four corresponding flats 36 on the valve stem. Thus, in this case, there are four possible rotational positions for the lever 50, relative to the valve stem 20, when the knob 40 is positioned thereon. Each rotational position is offset ninety degrees. In two of the four possible positions, each of which are offset one hundred and eighty degrees from each other, the convention will be satisfied in that the valve will be closed when the lever 50 is positioned laterally with respect to the longitudinally extending portion 52 and the valve will be open when the lever 50 is aligned with respect to the longitudinally extending portion. In the other two of the four possible positions, each of which are also offset one hundred and eighty degrees from each other, the convention will not be satisfied in that the valve will be closed when the lever 50 is aligned with respect to the longitudinally extending portion 52 and the valve will be open when the lever 50 is positioned laterally with respect to the longitudinally extending portion 52 of the valve.

The stop wings 48 shown in FIG. 7 cooperate with the stop surfaces 30 and other parts of the valve to facilitate and ensure proper positioning of the handle 40 so that the valve will operate in accordance with convention. Specifically, when the knob 40 is positioned on the valve stem 20 in either one of the two positions in which the convention will not be satisfied, the knob 40 will be locked against rotation. Period. This condition arises when the knob 40 is positioned on the valve stem so that the radial orientation of at least one end of the pin 34 and the radial orientation of at least one stop wing 48 are offset ninety degrees. In this situation, if the valve is closed, an end of the pin 34 abuts one of the stop surfaces 30 on at least one of the tabs 26 to prevent rotation of the stem 20 in one direction and at least one of the stop wings 48 engages a stop surface 30 on at least one of the tabs 26 to prevent rotation of the stem 20 in the opposite direction. Further, if the valve is open, an end of the pin 34 abuts one of the stop surfaces 30 on at least one of the tabs 26 to prevent rotation of the stem 20 in one direction and at least one of the stop wings 48 engages a stop surface 30 on at least one of the tabs 26 to prevent rotation of the stem 20 in the opposite direction. Essentially, the pin 34 and at least one stop wing 48 co-act with stop surfaces 30 to prevent the stem 20 from rotating in either direction. Conversely, when the knob 40 is positioned on the valve stem 20 so that the pin 34 and at least one of the stop wings 48 are radially aligned, the stem 20 may be rotated ninety degrees and the lever 50 on the knob will be positioned according to the convention, i.e., the valve will be open when the lever 50 is aligned with the longitudinally extending portion 52 of the valve housing 12 and the valve will be closed when the lever 50 is positioned so that it extends laterally relative to the portion 52.

If the valve stem 20 is in a rotational position such that the valve is not fully opened or closed, the knob 40 can only be positioned on the stem 20 in one of two possible relative rotational positions, each offset one hundred and eighty degrees from each other and, in either position, the convention will be satisfied. In case one attempts to position the knob 40 on the valve stem 20 in one of the other two possible relative rotational positions, the stop wings will engage the top of the tabs 26 before the flats 36 engage the flats 46 the knob 40. In other words, when the knob 40 is in one of these two other rotational positions, the knob 40 will be prevented from seating on the valve stem 20 and the flats 46 on the knob cannot engage the flats 36 on the valve stem 20. Again, when the knob 40 is positioned on the valve stem 20 so that the stop wings 48 are radially aligned with the pin 34, lever 50 of the knob 40 can be lowered onto the valve stem 20 and it will oriented so that it is in the conventional rotational positions when the valve is open and when the valve is closed.

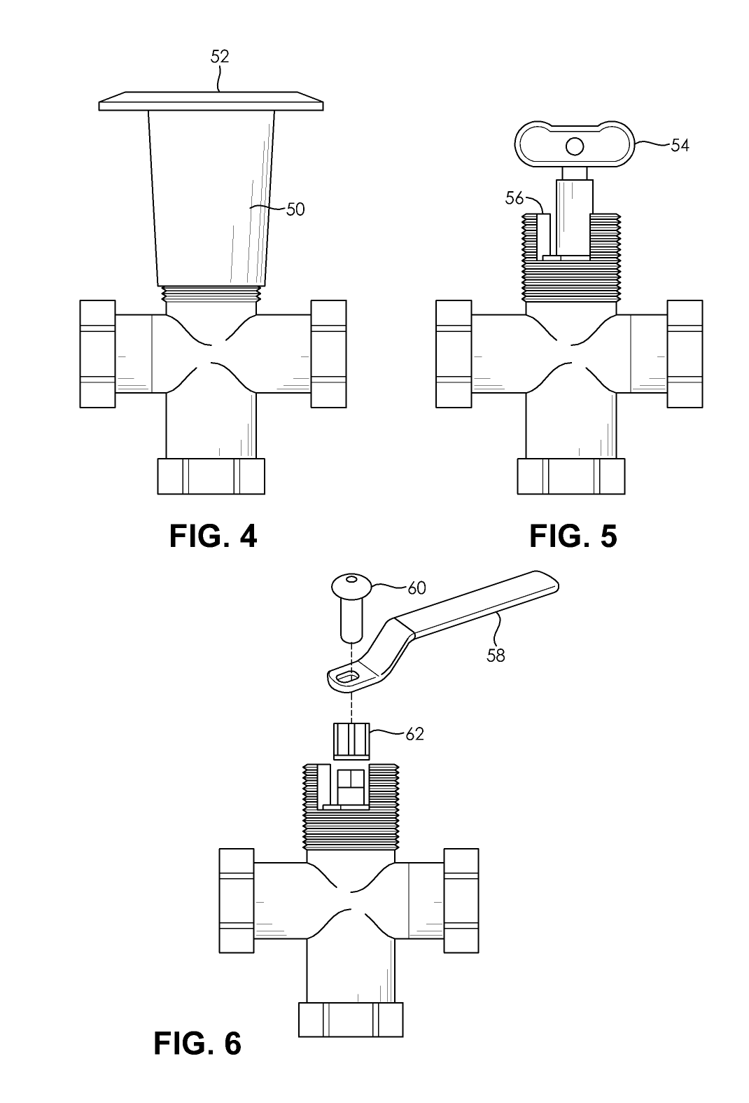

A gas valve cover or escutcheon 50 is shown in FIG. 4. The cover 50 is internally threaded to engage a portion of the external threads on the collar 22. The second end of the valve stem can be reached with a key through an opening indicated at 52 in the cover 50.

A loose key 54 is shown in FIG. 5. The key has a business end 56 with internal flats (not shown) operable to engage the flats 36 on the second, free end of the valve stem 20. The key 54 can be removed and put in a safe place, when not in use, to prevent unintended opening or closing of the valve 10.

A lever 58, shown in FIG. 6, may be attached to the valve stem 20 with a threaded fastener 60. A spacer 62 is shown and it can be positioned between the lever 58 and the second, free end of the valve stem 20.

Thus, it is seen that the valve assembly 10 includes a universal valve stem that can be operated by a wide variety of devices including knobs, handles, keys and levers. The second, free end of the valve stem 20 is within the collar 22 to prevent undesired meddling of little hands holding pliers. It is to be understood that the foregoing description of the invention is illustrative, only, of the elements which may be included in the inventive valve assembly and that these elements may be used together or in sub combinations to provide a new and unobvious valve assembly.

I claim:

1. A quarter turn ball valve assembly comprising a valve housing having cylindrical collar,
a fluid inlet in said housing,
a fluid outlet in said housing,
a ball positioned between said at least one inlet and said at least one outlet, said ball having at least one internal passageway and being supported in said valve housing for rotational movement between a first position in which said ball provides fluid communication between said at least one inlet and said at least one outlet, and a second position in which said ball prevents fluid communication between said at least one inlet and said at least one outlet,
a valve stem supported in said housing for rotation, said valve stem having a first end and a second end, said first end being coupled to said ball so that rotation of said stem causes corresponding rotation of said ball, and
a pin extending laterally through said valve stem,
wherein said collar has a free end, and first cut-out that defines first and second stop surfaces,
wherein, when said valve stem is in a first position, said ball is in said first position and said pin abuts said first stop surface and, when said valve stem is in a second position, said ball is in said second position and said pin abuts said second stop surface, and
wherein said second end of said valve stem does not extend beyond said free end of said collar.

2. The ball valve assembly claimed in claim 1 wherein flats are provided on said second end of said valve stem.

3. The ball valve assembly claimed in claim 2 further comprising a knob with flats operable to engage said flats on said second end of said valve stem when mounted thereon.

4. The ball valve assembly claimed in claim 3 wherein said knob further comprises a first stop wing that is positioned on said knob so that, when said knob is mounted on said valve stem, said first stop wing engages said first stop surface when said valve stem is in said first position.

5. The ball valve assembly claimed in claim 4 wherein, when said knob is mounted on said valve stem, said first stop wing engages said second stop surface when said valve stem is in said second position.

6. The ball valve assembly claimed in claim 3 including means for securing said knob to said second end of said valve stem when said knob is mounted thereon.

7. The ball valve assembly claimed in claim 4 wherein engagement between said first stop wing and said free end of said collar is operable to prevent said knob flats from engaging said valve stem flats over the course of at least a one hundred and eighty degree rotation of said knob relative to said valve stem.

8. A quarter turn ball valve assembly comprising
a valve housing having cylindrical collar,
a fluid inlet in said housing,
a fluid outlet in said housing,
a ball positioned between said at least one inlet and said at least one outlet, said ball having at least one internal passageway and being supported for rotational movement between a first position in which said ball provides fluid communication between said at least one inlet and said at least one outlet, and a second position in which said ball prevents fluid communication between said at least one inlet and said at least one outlet,
a valve stem supported in said housing for rotation between a first position and a second position, said valve stem having a first end and a second end, said first end being coupled to said ball so that rotation of said stem from said first position to said second position causes rotation of said ball from said first position to said second position,
wherein said collar has a first cut-out and a second cut-out defining a first tab and a second tab, each of said first and second tabs having a free end, and first and second sides each constituting a stop surface,
wherein said valve stem has a pin extending laterally therethrough so that, when said valve stem is in said first position, at least one end of said pin abuts said first stop surface on said first tab and, when said valve stem is in said second position, at least one end of said pin abuts said first stop surface on said second tab, and
wherein said second end of said valve stem does not extend beyond said free ends of said first and second tabs.

9. The ball valve assembly claimed in claim 8 wherein flats are provided on said second end of said valve stem.

10. The ball valve assembly claimed in claim 9 further comprising a knob with flats operable to engage said flats on said second end of said valve stem when mounted thereon.

11. The ball valve assembly claimed in claim 10 wherein said knob further comprises a first stop wing that is positioned on said knob so that, when said knob is mounted on said valve stem, said first stop wing engages said first stop surface of said first tab when said valve stem is in said first position.

12. The ball valve assembly claimed in claim 4 wherein, when said knob is mounted on said valve stem, said first stop wing engages said first stop surface of said second tab when said valve stem is in said second position.

13. The ball valve assembly claimed in claim 10 including means for securing said knob to said second end of said valve stem when said knob is mounted thereon.

14. The ball valve assembly claimed in claim 11 wherein said knob further comprises a second stop wing that is positioned on said knob so that, when said knob is mounted on said valve stem, said second stop wing engages said second stop surface of said first tab when said valve stem is in said first position.

15. The ball valve assembly claimed in claim 14 wherein engagement between said second stop wing and said free end of said second tab is operable to prevent said knob flats from engaging said valve stem flats over the course of a ninety degree rotation of said knob.
